(19) United States
(12) Patent Application Publication
(10) Pub. No.: US 2013/0160546 A1
(43) Pub. Date: Jun. 27, 2013

(54) GYRO SENSOR DRIVE CIRCUIT, GYRO SENSOR SYSTEM AND METHOD FOR DRIVING GYRO SENSOR

(71) Applicant: Samsung Electro-Mechanics Co., Ltd., Gyeonggi-do (KR)

(72) Inventors: Sung Tae Kim, Gyeonggi-do (KR); Chang Hyun Kim, Gyeonggi-do (KR)

(73) Assignee: SAMSUNG ELECTRO-MECHANICS CO., LTD., Gyeonggi-do (KR)

(21) Appl. No.: 13/725,797

(22) Filed: Dec. 21, 2012

(30) Foreign Application Priority Data
Dec. 26, 2011 (KR) 10-2011-0142420

(51) Int. Cl. G01C 19/56

(52) U.S. Cl. CPC G01C 19/56
USPC 73/504.12

(57) ABSTRACT

Disclosed herein are a gyro sensor drive circuit, a gyro sensor system, and a method for driving a gyro sensor. The gyro sensor drive circuit includes: a drive signal generating unit receiving a signal converted from an output signal of a gyro sensor to generate a drive signal to be applied to the gyro sensor; a resonance determining unit receiving the output signal of the gyro sensor, a demodulation signal for demodulating the output signal, or the drive signal to determine whether or not the gyro sensor resonates; and a start signal applying unit allowing the drive signal to be applied to the gyro sensor when it is determined that the gyro sensor resonates and allowing a start-up signal capable of generating resonance of the gyro sensor to be applied to the gyro sensor when it is determined that the gyro sensor does not resonate.

### CROSS REFERENCE(S) TO RELATED APPLICATIONS

This application claims the benefit under 35 U.S.C. Section 119 of Korean Patent Application Serial No. 10-2011-0142420, entitled “Gyro Sensor Drive Circuit, Gyro Sensor System, and Method for Driving Gyro Sensor” filed on Dec. 26, 2011, which is hereby incorporated by reference in its entirety into this application.

### BACKGROUND OF THE INVENTION

1. Technical Field

The present invention relates to a gyro sensor drive circuit, a gyro sensor system, and a method for driving a gyro sensor, and more particularly, to a gyro sensor drive circuit determining whether or not a gyro sensor resonates and allowing the gyro sensor to self-start when it is determined that the gyro sensor does not resonate, a gyro sensor system, and a method for driving a gyro sensor.

2. Description of the Related Art

A gyro sensor, which is a sensor detecting angular velocity, has been mainly used in posture control of an aircraft, a rocket, a robot, and the like, hand vibration compensation of a camera, a binoculars, and the like, an automobile sliding and rotating prevention system, navigation, and the like. Recently, the gyro sensor has been mounted in a smart phone, such that a utilization degree thereof is very high.

There are several types of gyro sensors such as a rotation type gyro sensor, a vibration type gyro sensor, a fluid type gyro sensor, an optical type gyro sensor, or the like. The vibration type gyro sensor has been currently used mainly in a mobile product. The vibration type gyro sensor may be divided into two types of gyro sensors such as a piezoelectric type gyro sensor and a capacitive type gyro sensor. In the vibration sensor, a capacitive type gyro sensor having a comb structure has been currently used mainly, and a piezoelectric type gyro sensor has been partially used.

The vibration type gyro sensor generally detects a magnitude of angular velocity by Coriolis' force Here, since the gyro sensor should be vibrated at a resonant frequency of a mass thereof in order to have a large signal magnitude, a drive circuit is very important. The drive circuit should originally self-resonate.

The gyro sensor mainly resonates by circuit noise or a signal suddenly increased at the time of first applying VDD. However, in some cases, an offset of the circuit is large, such that the gyro sensor may not self-resonate. In addition, when the gyro sensor is switched from a sleep mode in which it is not driven to an active mode in which it is driven, the gyro sensor may not be driven in the case in which it starts to be driven again.

### SUMMARY OF THE INVENTION

In the case in which the gyro sensor does not resonate due to several causes as described above, a noise signal, or the like, should be forcibly applied from the outside to the gyro sensor so that the gyro sensor may be resonance-driven. In this case, whether or not the gyro sensor resonates should be determined and the noise signal should be applied to the gyro sensor only when it is determined that the gyro sensor does not resonate, thereby allowing the gyro sensor to resonate.

An object of the present invention is to provide a technology of being capable of driving a gyro sensor by determining whether or not the gyro sensor resonates and applying a self-start signal to the gyro sensor in the case in which the gyro sensor does not self-resonate due to several causes.

According to an exemplary embodiment of the present invention, there is provided a gyro sensor drive circuit including: a drive signal generating unit receiving a signal converted from an output signal of a gyro sensor to generate a drive signal to be applied to the gyro sensor; a resonance determining unit receiving the output signal of the gyro sensor, a demodulation signal for demodulating the output signal, or the drive signal to determine whether or not the gyro sensor resonates; and a start signal applying unit allowing the drive signal to be applied to the gyro sensor when it is determined in the resonance determining unit that the gyro sensor resonates and allowing a start-up signal capable of generating resonance of the gyro sensor to be applied to the gyro sensor when it is determined in the resonance determining unit that the gyro sensor does not resonate.

The resonance determining unit may receive the output signal of the gyro sensor and perform sampling using a sampling frequency larger than a resonant frequency of the gyro sensor during a sampling period to determine whether or not the gyro sensor resonates.

The resonance determining unit may receive the demodulation signal output from the drive signal generating unit in order to demodulate the output signal of the gyro sensor or the drive signal generated in the drive signal generating unit and perform sampling using a sampling frequency larger than a resonant frequency of the gyro sensor during a sampling period to determine whether or not the gyro sensor resonates.

The start signal applying unit may include a metal oxide semiconductor field effect transistor (MOSFET) switch connected in parallel between the drive signal generating unit and an electrode of the gyro sensor, and the MOSFET switch may be driven according to a control signal applied when it is determined that the gyro sensor does not resonate, thereby allowing instantaneous voltage having a potential difference from the electrode of the gyro sensor to be applied to the electrode of the gyro sensor.

The start signal applying unit may include a digital multiplexer connected to a front end or a rear end of the drive signal generating unit, and the digital multiplexer may receive a signal converted from the output signal of the gyro sensor when being connected to the front end or the drive signal generated in the drive signal generating unit when being connected to the rear end as one input signal and receive a pulse signal having an adjacent frequency similar to a resonant frequency of the gyro sensor as another input signal, and output the pulse signal according to a control signal applied when it is determined that the gyro sensor does not resonate.

The gyro sensor drive circuit may further include a phase shifting unit receiving the output signal of the gyro sensor and generating a phase-shifted signal to provide the phase-shifted signal to the drive signal generating unit.

According to another exemplary embodiment of the present invention, there is provided a gyro sensor system including: a gyro sensor receiving a drive signal and outputs an output signal according to movement of an object; a gyro sensor drive circuit as described above determining whether or not the gyro sensor resonates, generating the drive signal to apply the drive signal to the gyro sensor when it is determined that the gyro sensor resonates, and applying a start-up signal capable of generating resonance of the gyro sensor to the gyro sensor when it is determined that the gyro sensor does not resonate; and a signal processing unit receiving the output signal of the gyro sensor and separating and outputting gyro component signals included in the output signal.

The signal processing unit may include: an analog signal processing unit receiving the output signal of the gyro sensor and separate drive component signals and the gyro component signals included in the output signal from each other to remove the drive component signals and output the gyro component signals; an analog-to-digital converting unit converting the signal processed in the analog signal processing unit into a digital signal; and a digital signal processing unit digitally processing and outputting the converted digital signal.

The gyro sensor drive circuit may apply the drive signal generated in the drive signal generating unit as a demodulation signal for separating the gyro component signals to the signal processing unit.

The gyro sensor may be a piezoelectric vibration type gyro sensor or a capacitive vibration type gyro sensor.

According to still another exemplary embodiment of the present invention, there is provided a method for driving a gyro sensor, the method including: receiving a signal converted from an output signal of a gyro sensor to generate a drive signal to be applied to the gyro sensor; receiving the output signal of the gyro sensor, a demodulation signal for demodulating the output signal, or the drive signal to determine whether or not the gyro sensor resonates; and applying the drive signal to the gyro sensor when it is determined that the gyro sensor resonates and applying a start-up signal capable of generating resonance of the gyro sensor to the gyro sensor when it is determined that the gyro sensor does not resonate, as a result of the determining of whether or not the gyro sensor resonates.

In the determining of whether or not the gyro sensor resonates, the output signal of the gyro sensor may be received and sampling may be performed using a sampling frequency larger than a resonant frequency of the gyro sensor during a sampling period to determine whether or not the gyro sensor resonates.

In the determining of whether or not the gyro sensor resonates, the demodulation signal output from the drive signal generating unit in order to demodulate the output signal of the gyro sensor or the drive signal generated in the drive signal generating unit may be received and sampling may be performed using a sampling frequency larger than a resonant frequency of the gyro sensor during a sampling period to determine whether or not the gyro sensor resonates.

In the applying of the drive signal or the start-up signal according to the result of the determining of whether or not the gyro sensor resonates, when it is determined that the gyro sensor does not resonate, a MOSFET switch connected in parallel with an electrode of the gyro sensor may be driven to apply instantaneous voltage having a potential difference from the electrode of the gyro sensor to the electrode of the gyro sensor.

In the applying of the drive signal or the start-up signal according to the result of the determining of whether or not the gyro sensor resonates, through a digital multiplexer receiving the drive signal as one input signal and receiving a pulse signal having an adjacent frequency similar to a resonant frequency of the gyro sensor as another input signal, when it is determined that the gyro sensor resonates, the drive signal may be output from the digital multiplexer to thereby be applied to the gyro sensor, and when it is determined that the gyro sensor does not resonate, the pulse signal may be output from the digital multiplexer to thereby be applied as the start-up signal to the gyro sensor.

In the applying of the drive signal or the start-up signal according to the result of the determining of whether or not the gyro sensor resonates, through a digital multiplexer receiving a signal converted from the output signal of the gyro sensor as one input signal and receiving a pulse signal having an adjacent frequency similar to a resonant frequency of the gyro sensor as another input signal, when it is determined that the gyro sensor resonates, the signal converted from the output signal of the gyro sensor may be output from the digital multiplexer and the drive signal may be generated from the signal converted from the output signal of the gyro sensor and output from the digital multiplexer to thereby be applied to the gyro sensor, and when it is determined that the gyro sensor does not resonate, the pulse signal may be output from the digital multiplexer to thereby be applied as the start-up signal to the gyro sensor.

The method may further include receiving the output signal of the gyro sensor and generating a phase-shifted signal to provide the phase-shifted signal as a signal for generating a drive signal.

### BRIEF DESCRIPTION OF THE DRAWINGS

FIG. 1 is a block diagram schematically showing a gyro sensor drive circuit according to a first exemplary embodiment of the present invention;

FIG. 2 is a diagram schematically showing an example of a start signal applying unit of the gyro sensor drive circuit shown in FIG. 1;

FIG. 3 is a diagram schematically showing another example of a start signal applying unit of the gyro sensor drive circuit shown in FIG. 1;

FIG. 4 is a block diagram schematically showing a gyro sensor system according to a second exemplary embodiment of the present invention;

FIG. 5 is a diagram schematically showing non-resonance characteristics according to offset in a gyro sensor;

FIG. 6 is a diagram showing a resonance sensing principle in the gyro sensor drive circuit according to the exemplary embodiment of the present invention;

FIG. 7 is a flow chart schematically showing a method for driving a gyro sensor according to a third exemplary embodiment of the present invention;

FIG. 8 is a flow chart schematically showing an example of a partial process of the method for driving a gyro sensor shown in FIG. 7; and

FIG. 9 is a flow chart schematically showing another example of a partial process of the method for driving a gyro sensor shown in FIG. 7.

### DESCRIPTION OF THE PREFERRED EMBODIMENTS

Exemplary embodiments of the present invention for accomplishing the above-mentioned objects will be described with reference to the accompanying drawings. In the description, the same reference numerals will be used to describe the same components of which detailed description will be omitted in order to allow those skilled in the art to understand the present invention.

In the specification, it will be understood that unless a term such as ‘directly’ is not used in a connection, coupling, or disposition relationship between one component and another component, one component may be ‘directly connected to’, ‘directly coupled to’ or ‘directly disposed to’ another element or be connected to, coupled to, or disposed to another element, having the other element intervening therebetween. In addition, this may also be applied to terms including the meaning of a contact such as ‘on’, ‘above’, ‘below’, ‘under’, or the like. In the case in which a standard element is upset or is changed in a direction, terms related to a direction may be interpreted to include a relative direction concept.

Although a singular form is used in the present description, it may include a plural form as long as it is opposite to the concept of the present invention and is not contradictory in view of interpretation or is used as clearly different meaning. It should be understood that “include”, “have”, “comprise”, “be configured to include”, and the like, used in the present description do not exclude presence or addition of one or more other characteristic, component, or a combination thereof.

Prior to detailed description of the present invention, resonance of a gyro sensor will be schematically described.

An object has a natural frequency and resonates when force in a natural frequency band is applied from the outside thereto. When voltage is applied to two parallel electrodes in the gyro sensor, in the case of a piezoelectric scheme, stress is generated in a piezoelectric material to change an interval between the two electrodes, and in the case of a capacitive scheme, a + charge and a − charge move by repulsive or attractive force therebetween.

However, even in the case in which the voltage is applied, a mass of the gyro sensor is not significantly changed. In the case in which a frequency of drive voltage applied to the electrode of the gyro sensor coincides with a frequency of the mass of the gyro sensor, the mass vibrates, such that the gyro sensor resonates. In this case, the gyro sensor generates a Coriolis' output signal. This output signal of the gyro sensor is amplified through an amplifier and a phase shifter and then applied as a drive signal of the gyro sensor to form a close loop, such that the gyro sensor resonates.

However, even in the case in which the close loop is formed, the gyro sensor does not necessarily resonate. A cause of allowing the gyro sensor to resonate, that is, a signal capable of vibrating the mass is required in order to form a loop capable of allowing the gyro sensor to resonate. This signal may be noise or external impact. In addition, a level of the signal needs to be a predetermined level or more. The reason is that since a circuit itself is not a completely ideal circuit, there are offset in each component of the circuit. When a signal having a level exceeding this offset is applied, a resonant loop is formed, such that the gyro sensor resonates.

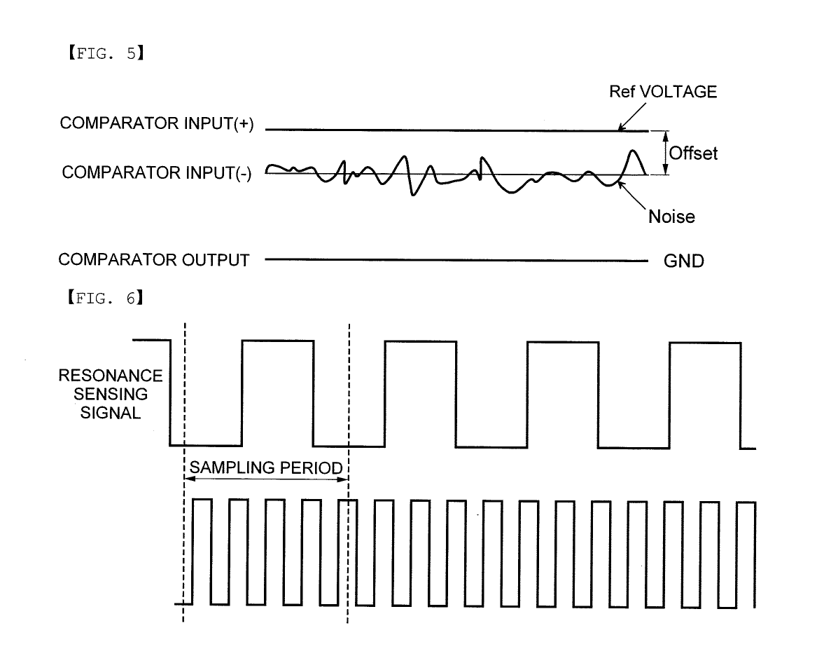

FIG. 5 shows a state in which an output of a comparator is zero since this signal does not exceed the offset. That is, as shown in FIG. 5, even though a signal capable of generating the resonance of the gyro sensor, for example, noise is input, the gyro sensor may not resonate due to the offset of the gyro sensor itself.

According to the present invention, in this case or in the case in which resonance is not generated in a sensor that may not self-resonate, the sensor is allowed to resonate, such that it may self-start.

First, a gyro sensor drive circuit according to a first exemplary embodiment of the preset invention will be described in detail with reference to the accompanying drawings. In the specification, the same reference numerals will be used in order to describe the same components throughout the accompanying drawings.

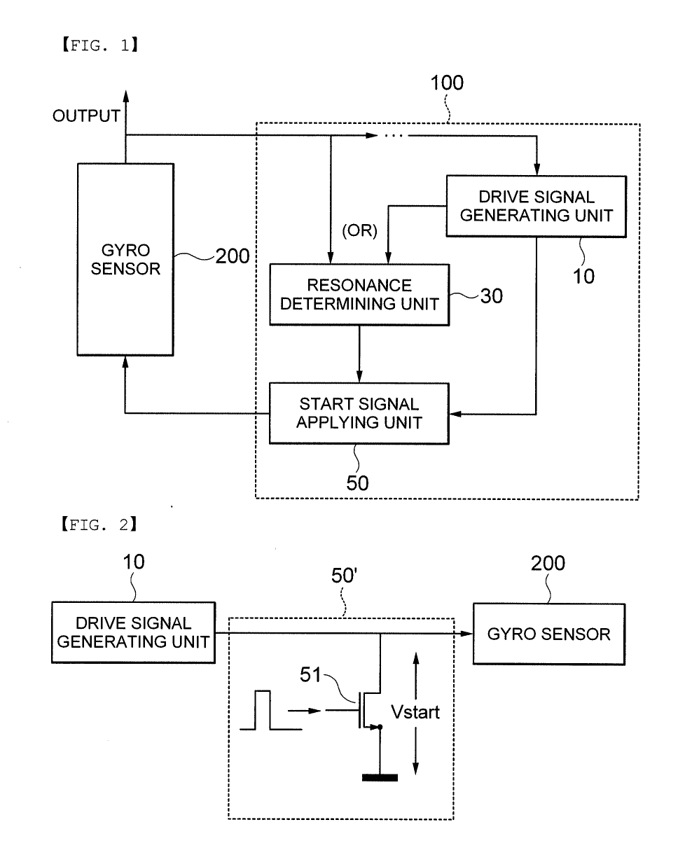

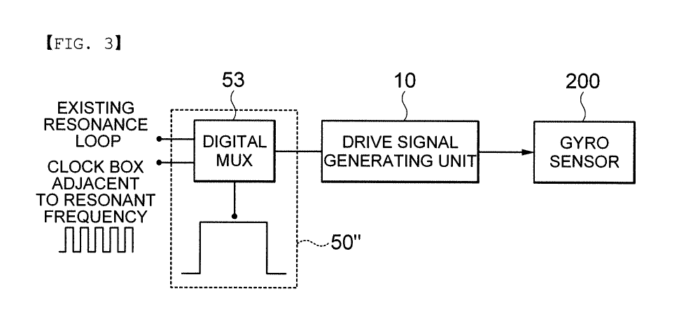

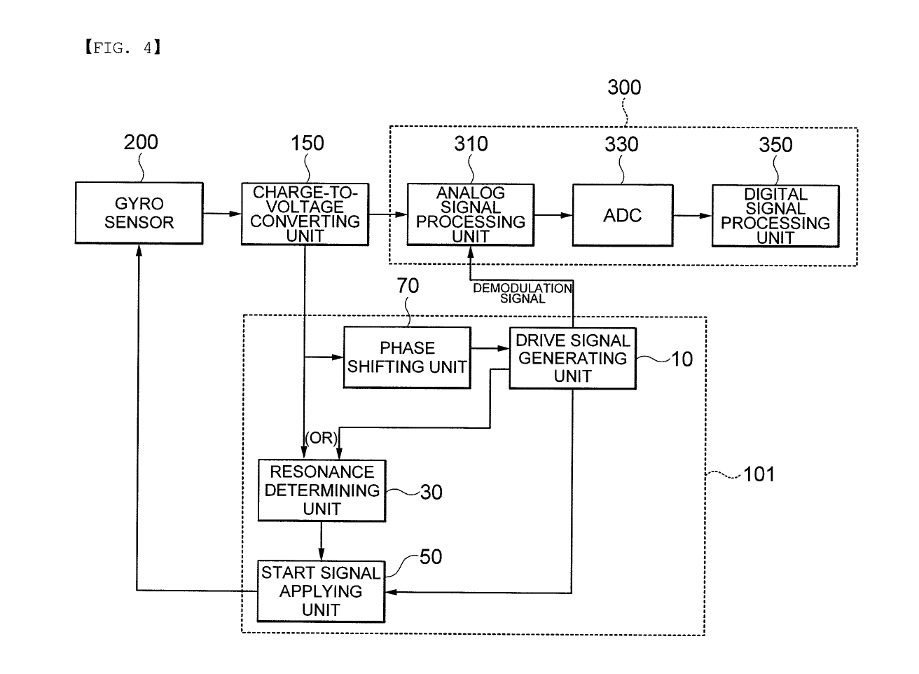

FIG. 1 is a block diagram schematically showing a gyro sensor drive circuit according to a first exemplary embodiment of the present invention; FIG. 2 is a diagram schematically showing an example of a start signal applying unit of the gyro sensor drive circuit shown in FIG. 1; FIG. 3 is a diagram schematically showing another example of a start signal applying unit of the gyro sensor drive circuit shown in FIG. 1; and FIG. 4 is a block diagram schematically showing a gyro sensor system according to a second exemplary embodiment of the present invention. In addition, FIG. 5 is a diagram schematically showing non-resonance characteristics according to offset in a gyro sensor; and FIG. 6 is a diagram showing a resonance sensing principle in the gyro sensor drive circuit according to the exemplary embodiment of the present invention.

First, the gyro sensor drive circuit according to the exemplary embodiment of the present invention will be described with reference to FIGS. 1 to 4.

Referring to FIG. 1, the gyro sensor drive circuit 100 may be configured to include a drive signal generating unit 10, a resonance determining unit 30, and a start signal applying unit 50. In addition, referring to FIG. 4, the gyro sensor drive circuit 101 may further include a phase shifting unit 70.

Describing the drive signal generating unit 10 of FIG. 1, the drive signal generating unit 10 receives a signal converted from an output signal of a gyro sensor 200 to generate a drive signal to be applied to the gyro sensor 200. Here, the output signal of the gyro sensor 200 input to the drive signal generating unit 10 may be a sensor signal output directly from the gyro sensor 200, a signal output from the gyro sensor 200 and amplified in, for example, a charge-voltage compensating unit 150 (See FIG. 4), or an output signal output from the gyro sensor 200 and then phase-shifted through, for example, a phase shifting unit 70 of FIG. 4.

Referring to FIG. 4, as an example, the drive signal generating unit 10 may output a demodulation signal for demodulating an output signal of the gyro sensor 200 in a signal processing unit 300 of a gyro sensor system. Here, the demodulation signal may be a drive signal generated from the drive signal generating unit 10. Here, as an example, the demodulation signal output from the drive signal generating unit 10 may be applied to the resonance determining unit 30 and be used to determine whether or not the gyro sensor 200 resonates.

As an example, the gyro sensor 200 to which the drive signal is to be applied may be a piezoelectric vibration type gyro sensor or a capacitive vibration type gyro sensor.

Continuously, the resonance determining unit 30 will be described with reference to FIG. 1. In FIG. 1, the resonance determining unit 30 receives the output signal of the gyro sensor 200, the demodulation signal for demodulating the output signal, or the drive signal to determine whether or not the gyro sensor 200 resonates. In FIGS. 1 and 2, the resonance determining unit 30 may selectively receive any one of the output signal of the gyro sensor 200 and the drive signal generated from the drive signal generating unit 10. Here, the selective reception means that the resonance determining unit 30 receives any one of the output signal and the drive signal according to the exemplary embodiment of the present invention. There are various methods of determining whether or not a gyro sensor resonates in the resonance determining unit 30. Specific examples thereof will be described in the following. However, these examples are only illustrative and do not limit the scope of the present invention. That is, whether or not a gyro sensor resonates may also be determined by the known method that is not illustrated.

The resonance determining unit 30 will be further described with reference to FIG. 6. Whether or not the gyro sensor 200 resonates may be sensed by several methods. One method of sensing whether or not the gyro sensor 200 resonates is to use the output signal of the gyro sensor 200 since a frequency in a resonance band at the time of resonance is generated when the output signal of the gyro sensor 200 is applied to a comparator (not shown). Alternatively, a separate comparator is provided, such that even though the output signal of the gyro sensor 200 is not applied, whether or not the gyro sensor 200 resonates may be sensed using the drive signal or the demodulation signal. When it is assumed that the gyro sensor itself is a modulator mixing the drive signal, which is a carrier, and a gyro signal, which is an original signal, with each other, a demodulator is required for demodulating the gyro signal, which is the original signal. In this case, demodulation signal clocks are required. In the case in which the gyro sensor 200 resonates, these demodulation signal clocks, which are signals generated by phase-shifting the output signal of the gyro sensor 200 by 90 degrees, passes through the comparator (not shown), such that a square wave in a resonant frequency band is generated.

As an example, the resonance determining unit 30 may receive the output signal of the gyro sensor 200 and perform the sampling using a sampling frequency larger than a resonant frequency of the gyro sensor 200 during a sampling period to determine whether or not the gyro sensor resonates. Here, the signal input to the resonance determining unit 30 so that whether or not the gyro sensor resonates is determined is the output signal of the gyro sensor 200. The output signal of the gyro sensor 200, which is a signal output directly from the gyro sensor 200 or a signal passing through the charge-to-voltage converting unit 150 as shown in FIG. 4 by way of example, may pass through the comparator (not shown) and be then input to the resonance determining unit 30.

In the case in which a resonance sensing signal shown in FIG. 6 is a signal output from the gyro sensor, passing through the comparator (not shown), and then input to the resonance determining unit 30, a sampling frequency is much larger than a natural resonant frequency of the gyro sensor 200. Only in the case in which the sampling frequency is larger than the natural resonant frequency, when the resonance sensing signal is sampled and counted using the sampling frequency during a predetermined sampling period, if the counted result is not “0” or the maximum numeral, it may be determined that the gyro sensor 200 resonates. Unlike the case shown in FIG. 6, in the case in which the resonance sensing signal, for example, the output signal of the gyro sensor 200 is input only as a high or low signal, a counted result is indicated as “0” or the maximum numeral. In this case, it may be determined that the gyro sensor 200 does not resonate. The meaning that the output signal is low is that there is no output of the gyro sensor 200. Here, the maximum numeral may be determined according to a resonant frequency (f₀) and f₀/fₛ in the case of a sampling frequency (fₛ) In addition, in the case in which whether or not the gyro sensor 200 resonates is determined according to whether or not the counted result corresponds to “0” or the maximum numeral, the sampling period needs to be temporally larger than 1/(2*resonant frequency). The reason is that the sampling period needs to be temporally larger than 1/(2*f₀) in order to include at least a portion of a high period of the resonance sensing signal having the resonant frequency. In addition, in this case, the sampling period may be temporally smaller than 1/resonant frequency, that is, 1/f₀. As a result, the maximum numeral may be changed according to a setting range of the sampling period, for example, the maximum range of the sampling period.

Further, as another example, the resonance determining unit 30 may receive the demodulation signal (See FIG. 4) output from the drive signal generating unit 10 in order to demodulate the output signal of the gyro sensor 200 or the drive signal generated in the drive signal generating unit 10 and perform the sampling using a sampling frequency larger than the resonant frequency of the gyro sensor 200 during the sampling period to determine whether or not the gyro sensor 200 resonates. In this case, the resonance sensing signal shown in FIG. 6 may be the drive signal generated in the drive signal generating unit 10 or the demodulation signal output in order to demodulate the output signal of the gyro sensor 200. In this case, the sampling frequency is much larger than the natural resonant frequency of the gyro sensor 200. When the resonance sensing signal, which is the drive signal, is sampled and counted using the sampling frequency, in the case in which the counted result is not “0” or the maximum numeral, it may be determined that the gyro sensor 200 resonates. On the other hand, in the case in which the counted result is “0” or the maximum numeral, it corresponds to a case in which the resonance sensing signal, which is the drive signal phase-shifted from the output of the gyro sensor 200 and fed back, is input only as a high or low signal, such that it may be determined that the gyro sensor 200 does not resonate.

Next, the start signal applying unit 50 will be described in detail with reference to FIG. 1. The start signal applying unit 50 of FIG. 1 performs a control so that the drive signal or a start-up signal is input to the gyro sensor 200 according to the determination of the resonance determining unit 30 for whether or not the gyro sensor resonates. That is, when it is determined in the resonance determining unit 30 that the gyro sensor 200 resonates, the start signal applying unit 50 may perform a control so that the drive signal is applied to the gyro sensor 200. On the other hand, when it is determined in the resonance determining unit 30 that the gyro sensor 200 does not resonate, the start signal applying unit 50 may perform a control so that the start-up signal capable of generating resonance of the gyro sensor 200 is applied to the gyro sensor 200.

A start signal applying unit 50′ or 50″ will be further described with reference to FIGS. 2 and 3.

Referring to FIG. 2, as an example, the start signal applying unit 50′ may include a metal oxide semiconductor field effect transistor (MOSFET) switch 51 connected in parallel between the drive signal generating unit 10 and the electrode of the gyro sensor 200. That is, one terminal, for example, a drain electrode, of the MOSFET switch 51 is connected to the drive signal generating unit 10 and a connection node of the electrode of the gyro sensor, and the other terminal, for example, a source electrode, of the MOSFET switch 51 is connected to a reference voltage, a ground, or the like, such that the MOSFET switch 51 may have a significant potential difference Vstart from the electrode of the gyro sensor 200. Here, the potential difference between the source electrode and the gyro sensor may be transferred in a pulse form to the gyro sensor to change a mass of the gyro sensor, thereby driving the gyro sensor 200.

The MOSFET switch 51 may receive a control signal of the resonance determining unit 30 according to whether or not the gyro sensor 200 resonates as a gate drive signal. For example, when it is determined in the resonance determining unit 30 that the gyro sensor 200 resonates, the gate drive signal may be not applied to a gate electrode of the MOSFET switch 51, and when it is determined in the resonance determining unit 30 that the gyro sensor 200 does not resonate, the gate drive signal may be applied to the gate electrode of the MOSFET switch 51. Here, the gate drive signal may be a pulse signal.

Here, referring to FIG. 2, when it is determined that the gyro sensor 200 resonates, since the gate drive signal is not applied to the MOSFET switch 51, the MOSFET switch 51 is turned off, such that the drive signal generated in the drive signal generating unit 10 may be applied, as it is, to the electrode of the gyro sensor. In addition, when it is determined that the gyro sensor 200 does not resonate, the pulse signal, which is the gate drive signal, is applied to the gate electrode of the MOSFET switch 51, such that the MOSFET switch 51 is turned on. At the time of non-resonance, the electrode of the gyro sensor 200 is maintained at a predetermined voltage. At this time, the switch is turned on during a predetermined period of the MOSFET switch 51, for example, according to the pulse signal. When the MOSFET switch 51 is turned on, the drain electrode and the source electrode of the MOSFET switch 51 connected to a connection node between the drive signal generating unit 10 and the electrode of the gyro sensor are conducted to each other, such that the connection node between the drive signal generating unit 10 and the electrode of the gyro sensor and the source electrode of the MOSFET switch 51 have the same voltage Here, since the source electrode of the MOSFET switch 51 has voltage with a significant potential difference from the electrode of the gyro sensor 200, the voltage Vstart with the significant potential difference is applied to the electrode of the gyro sensor, such that electrode voltage of the gyro sensor 200 instantaneously fluctuates. This fluctuation of the electrode voltage of the gyro sensor 200 may change the mass of the gyro sensor 200 to allow the gyro sensor 200 to resonate. The source electrode of the MOSFET switch 51 may be connected to GND, VDD or another reference voltage so as to have a significant potential difference from the electrode of the gyro sensor.

Another example will be described with reference to FIG. 3. A start signal applying unit 50″ may include a digital multiplexer 53 connected to a front end or a rear end of the drive signal generating unit 10. FIG. 3 shows that the digital multiplexer 53 is provided at the front end of the drive signal generating unit 10. However, it may be appreciated from the following description and FIG. 3 that although not shown, even in the case in which the digital multiplexer 53 is provided at the rear end of the drive signal generating unit 10, a result that is substantially the same as that of FIG. 3 may be obtained.

Here, referring to FIG. 3, the digital multiplexer 53 may be connected to the front end of the drive signal generating unit 10, and receive a signal converted from the output signal of the gyro sensor 200 as one input signal and receive a pulse signal having an adjacent frequency similar to the resonant frequency of the gyro sensor 200 as another input signal to selectively output any one of them according to a control signal. The pulse signal having the adjacent frequency similar to the resonant frequency may be a clock signal generated from an oscillator (not shown). Here, the control signal, which is a control signal according to the determination result of the resonance determining unit 30, may allow the signal converted from the output signal of the gyro sensor 200 to be output when it is determined that the gyro sensor 200 resonates and allow the pulse signal having the adjacent frequency similar to the resonant frequency of the gyro sensor 200 when it is determined that the gyro sensor 200 does not resonate. That is, the digital multiplexer 53 serves as a data selector. The signal converted from the output signal of the gyro sensor 200 may be a square wave signal. Therefore, a signal output to the digital multiplexer 53 may be a square wave signal. The signal converted from the output signal of the gyro sensor 200 may be an output of the gyro sensor 200, for example, a direct output of the gyro sensor 200, or a signal generated by phase-shifting an output passing through the charge-to-voltage converting unit 150 of FIG. 4 through the phase shifting unit 70 of FIG. 4 and then converting the phase-shifted output into the square wave signal.

Unlike a case shown in FIG. 3, in the case in which the digital multiplexer 53 is connected to the rear end of the drive signal generating unit 10, that is, the drive signal generating unit 10 and the electrode of the gyro sensor, the digital multiplexer may receive the drive signal generated in the drive signal generating unit as one input signal, receive the pulse signal having the adjacent frequency similar to the resonant frequency of the gyro sensor as another input signal, and receive the control signal according to the determination result of the resonance determining unit to selectively output any one of them. Here, when it is determined that the gyro sensor resonates, the digital multiplexer 53 may allow the drive signal to be output, and when it is determined that the gyro sensor does not resonate, the digital multiplexer 53 may allow the pulse signal having the adjacent frequency similar to the resonant frequency. Since the gyro sensor has a natural resonant frequency, which has a similar level even though it is slightly different according to a process, when the drive signal for generating resonance is converted into a signal similar to the drive signal and then applied to the gyro sensor, the gyro sensor slightly fluctuates, such that a fluctuating signal in an existing resonance loop again forms a loop, whereby the gyro sensor starts to self-resonate. The signal output from the digital multiplexer may be a pulse signal. FIG. 9 and a third exemplary embodiment to be described below will be referred.

Next, referring to FIG. 4, the gyro sensor drive circuit 101 according to the exemplary embodiment of the present invention may further include a phase shifting unit 70. Here, the phase shifting unit 70 may receive the output signal of the gyro sensor 200 and generate a phase-shifted signal to provide the phase-shifted signal to the drive signal generating unit 10. The output signal of the gyro sensor 200 input to the phase shifting unit 70 may be an output signal of the charge-to-voltage converting unit 150 as shown in FIG. 4 or a signal (not shown) output directly from the gyro sensor 200. For example, the phase shifting unit 70 may be formed of a phase shifter. The charge-to-voltage converting unit 150 receives the output signal from the gyro sensor 200 and converts the output signal into an amplified voltage signal.

First, a gyro sensor system according to a second exemplary embodiment of the preset invention will be described in detail with reference to the accompanying drawings. Hereinafter, FIG. 4, examples of the gyro sensor drive circuit 100 according to the first exemplary embodiment of the present invention described above, and FIGS. 1 to 3 may be referred. Therefore, overlapped descriptions will be omitted.

FIG. 4 is a block diagram schematically showing a gyro sensor system according to a second exemplary embodiment of the present invention.

The gyro sensor system according to the second exemplary embodiment of the present invention will be described with reference to FIG. 4.

As an example, the gyro sensor system may be configured to include the gyro sensor 200, the gyro sensor drive circuit 101, and a signal processing unit 300. Here, the gyro sensor drive circuit 101 shown in FIG. 4 may be replaced by the gyro sensor drive circuit 100 or 101 obtained from FIGS. 1 to 3.

In FIG. 4, the gyro sensor 200 receives a drive signal and outputs an output signal according to movement of an object. Here, the drive signal is generated in the drive signal generating unit 10. In the case in which the gyro sensor 200 does not resonate even through it receives the signal generated in the drive signal generating unit 10, a start-up signal applied according to a control of the start signal applying unit 50, 50′ or 50″ of the gyro sensor drive circuit 100 or 101 shown in FIG. 1 or 4 may be applied as a drive signal for resonance of the gyro sensor 200.

As an example, the gyro sensor 200 may be a piezoelectric vibration type gyro sensor or a capacitive vibration type gyro sensor.

Continuously referring to FIG. 4, the gyro sensor drive circuit 101 (See a reference numeral 100 of FIG. 1) determines whether or not the gyro sensor 200 resonates, and generates the drive signal to apply the drive signal to the gyro sensor 200 when it is determined that the gyro sensor 200 resonates. In addition, the gyro sensor drive signal 101 may apply the start-up signal capable of generating the resonance of the gyro sensor 200 to the gyro sensor 200 when it is determined that the gyro sensor 200 does not resonate.

The gyro sensor drive circuit 101 may be a circuit applying the drive signal to the gyro sensor 200, and the drive signal generated in the gyro sensor drive circuit 101 may be a square wave signal generated by receiving the output signal from the gyro sensor 200 and phase-shifting the output signal. Here, the output signal from the gyro sensor 200 input in order to generate the drive signal may be a signal output directly from the gyro sensor 200 or output through the charge-to-voltage converting unit 150 as shown in FIG. 4.

According to the present embodiment, as the gyro sensor drive circuit 101, the gyro sensor drive circuits 100 and 101 according to the first exemplary embodiment of the present invention described above may be used.

In addition, as an example, as shown in FIG. 4, the gyro sensor drive circuit 101 may apply the drive signal generated in the drive signal generating unit 10 as the demodulation signal to the signal processing unit 300. Here, the drive signal applied from the drive signal generating unit 10 to the signal processing unit 300 is a signal for separating gyro component signals. Alternatively, unlike a case shown in FIG. 4, a separate demodulation signal applying unit (not shown) rather than the drive signal generating unit 10 may be provided and apply the drive signal received from the drive signal generating unit as the demodulation signal to the signal processing unit 300.

Continuously, the signal processing unit 300 will be described with reference to FIG. 4.

In FIG. 4, the signal processing unit 300 receives the output signal of the gyro sensor 200 and separates and outputs gyro component signals included in the output signal. Here, the output signal of the gyro sensor 200 input to the signal processing unit 300 may be a signal output through the charge-to-voltage converting unit 150 shown in FIG. 4. Alternatively, the output signal of the gyro sensor 200 input to the signal processing unit 300 may be a signal output directly from the gyro sensor 200 unlike a case shown in FIG. 4. In this case, a component amplifying and converting a charge output of the gyro sensor 200 into a voltage signal may be included in the signal processing unit 300 or the gyro sensor 200.

Describing in more detail with reference to FIG. 4, as an example, the signal processing unit 300 may include an analog signal processing unit 310, an analog-to-digital converting unit 330, and a digital signal processing unit 350.

Here, the analog signal processing unit 310 may receive the output signal of the gyro sensor 200 and separate drive component signals and gyro component signals included in the output signal from each other to remove the drive component signals. In addition, the analog signal processing unit 310 outputs the gyro component signals in which the drive component signals are removed.

Here, as an example, the drive signal generated in the drive signal generating unit 10 of the gyro sensor drive circuit 100 or 101 may be applied to the signal processing unit 300, for example, the analog signal processing unit 310 of the signal processing unit 300. The drive signal applied to the analog signal processing unit 310 may be used as the demodulation signal for separating the gyro component signals.

For example, the analog signal processing unit 310 may include a demodulator (not shown) receiving an output signal of the charge-to-voltage converting unit 150 of FIG. 4 and separating the drive component signals and the gyro component signals from each other using the demodulation signal and a low pass filter (not shown) removing the drive component signals separated in the demodulator. Here, the drive component signal means a signal component having the same frequency as that of the drive signal but having a phase different from that of the drive signal among components included in the output signal of the gyro sensor 200, and the gyro component signal means the remaining signal component other than the drive component signal or a signal component including a natural gyro signal component.

A process of separating the drive signal into the drive component signals and the gyro component signals included in the output signal of the gyro sensor 200 using the demodulation signal will be briefly described. In the output signal of the gyro sensor applied to the analog signal processing unit 310 and subjected to the charge-to-voltage conversion amplification, the drive component signals and the gyro component signals are mixed with each other. Generally, the gyro component signal has a phase leading by 90 degrees as compared to the drive component signal. Here, when a square wave signal having the same phase as that of the gyro component signal is applied as the demodulation signal, the drive component signals may be demodulated by the demodulation signal and be averaged to thereby be averaged to a reference voltage Vref. On the other hand, the gyro component signals are demodulated by the demodulation signal and are averaged to thereby have a predetermined value slightly spaced apart from the reference voltage Vref. The drive component signals may be removed through the low pass filter (not shown) of the analog signal processing unit 310.

Next, the analog-to-digital converting unit 330 converts the signal processed in the analog signal processing unit 310 into a digital signal.

Next, the digital signal processing unit 350 digitally processes and outputs the digital signal converted in the analog-to-digital converting unit 330. Here, an output value, for example, angular velocity data, of the gyro sensor 200 may be obtained from the digital output.

In addition, referring to FIG. 4, as an example, the gyro sensor system may include the charge-to-voltage converting unit 150 provided between the gyro sensor 200 and the signal processing unit 300. The charge-to-voltage converting unit 150 receives the output signal of the gyro sensor 200 and amplifies and converts the output signal into a voltage signal. Although FIG. 4 shows that the charge-to-voltage converting unit 150 is provided as a separate component from the gyro sensor 200 or the signal processing unit 300, it may also be understood that the charge-to-voltage converting unit 150 may be a component included in the gyro sensor 200 or the signal processing unit 300.

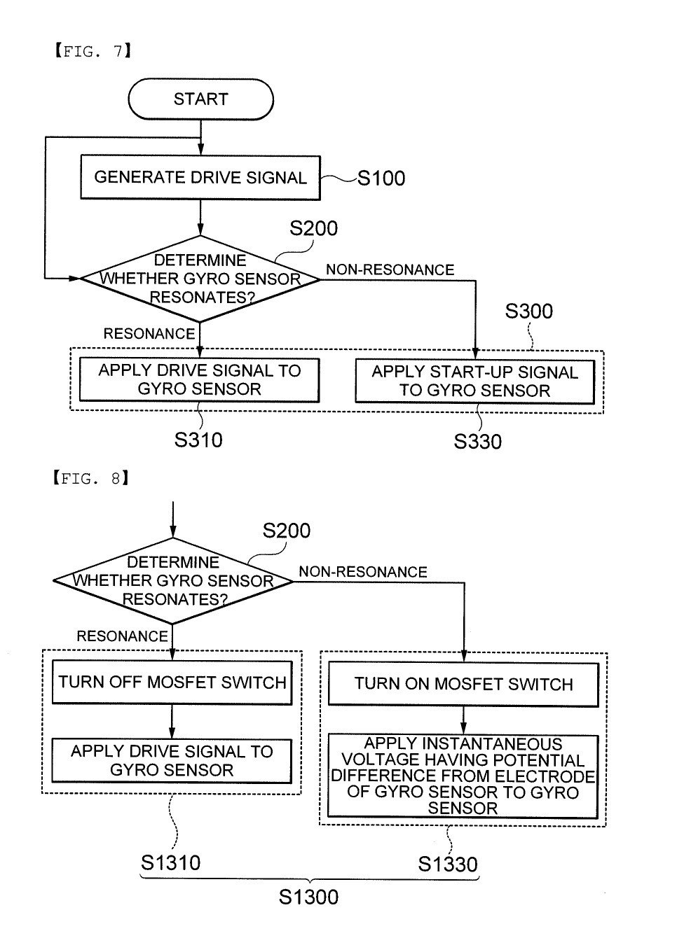

Next, a method for driving a gyro sensor according to a third exemplary embodiment of the preset invention will be described in detail with reference to the accompanying drawings. Hereinafter, FIGS. 7 to 9, the gyro sensor drive circuit according to the first exemplary embodiment of the present invention described above, examples of the gyro sensor system according to the second exemplary embodiment of the present invention described above, and FIGS. 1 to 6 may be referred. Therefore, overlapped descriptions will be omitted.

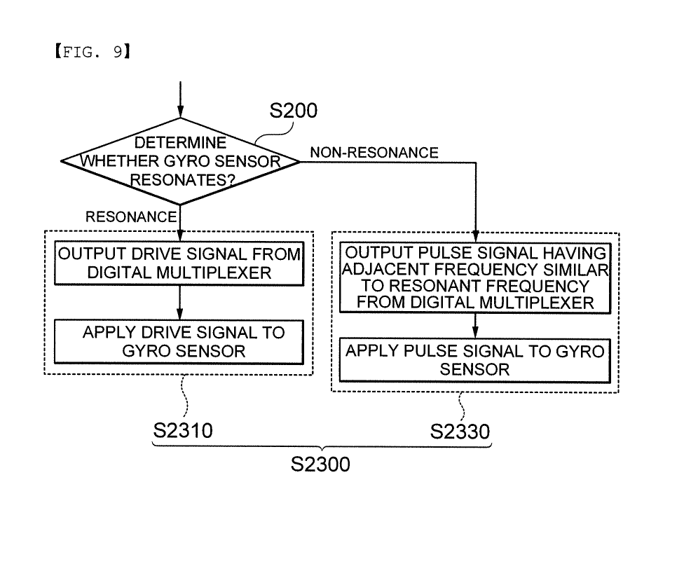

FIG. 7 is a flow chart schematically showing a method for driving a gyro sensor according to a third exemplary embodiment of the present invention; FIG. 8 is a flow chart schematically showing an example of a partial process of the method for driving a gyro sensor shown in FIG. 7; and FIG. 9 is a flow chart schematically showing another example of a partial process of the method for driving a gyro sensor shown in FIG. 7.

The method for driving a gyro sensor according to the third exemplary embodiment of the present invention will be described with reference to FIG. 7.

In FIG. 7, the method for driving a gyro sensor may include generating a drive signal (S100), determining whether or not a gyro sensor 200 resonates (S200), and applying a signal to the gyro sensor 200 (S300).

First, in the generating of the drive signal (S100) of FIG. 7, a signal converted from an output signal of the gyro sensor 200 is received to generate the drive signal to be applied to the gyro sensor 200.

Although not shown, as another example, the method for driving a gyro sensor may further include, before the generating of the drive signal (S100), receiving the output signal of the gyro sensor 200 and generating a phase-shifted signal to provide the phase-shifted signal as a signal for generating a drive signal.

In addition, referring to FIG. 4, as an example, a drive signal generating unit 10 may output a demodulation signal for demodulating the output signal of the gyro sensor 200 in a signal processing unit 300 of a gyro sensor system. Although not shown, this demodulation signal may be output in the generating of the drive signal (S100) of FIG. 7, and the output demodulation signal may be input to the determining of whether or not the gyro sensor 200 resonates (S200) to thereby be used to determine whether or not the gyro sensor 200 resonates.

Next, in the determining of whether or not the gyro sensor 200 resonates (S200), the output signal of the gyro sensor 200, the demodulation signal for demodulating the output signal, or the drive signal may be received to determine whether or not the gyro sensor 200 resonates. In FIG. 7, two arrows are input to the determining of whether or not the gyro sensor 200 resonates (S200). That is, it may be understood that the output signal of the gyro sensor 200 and the drive signal generated in the generating of the drive signal (S100) are input to the determining of whether or not the gyro sensor 200 resonates (S200). Here, any one of the output signal of the gyro sensor 200 and the drive signal may be input to the determining of whether or not the gyro sensor 200 resonates (S200) according to the exemplary embodiment of the present invention.

A further description will be provided with reference to FIG. 6. As an example, in the determining of whether or not the gyro sensor 200 resonates (S200), the output signal of the gyro sensor 200 may be received and the sampling may be performed using a sampling frequency larger than a resonant frequency of the gyro sensor 200 during a sampling period to determine whether or not the gyro sensor resonates.

Further, referring to FIG. 6, as another example, in the determining of whether or not the gyro sensor 200 resonates (S200), the demodulation signal output from the drive signal generating unit 10 in order to demodulate the output signal of the gyro sensor 200 or the drive signal generated in the drive signal generating unit 10 may be received and the sampling may be performed using a sampling frequency larger than the resonant frequency of the gyro sensor 200 during the sampling period to determine whether or not the gyro sensor 200 resonates.

Then, in the applying of the signal to the gyro sensor 200 (S300) of FIG. 7, a control is performed so that the signal applied to the gyro sensor 200 is changed according to a result of determining whether or not the gyro sensor 200 resonates.

For example, when it is determined in the determining of whether or not the gyro sensor 200 resonates (S200) that the gyro sensor 200 resonates, in the applying of the signal to the gyro sensor 200 (S300), the drive signal is applied to the gyro sensor 200. On the other hand, when it is determined in the determining of whether or not the gyro sensor 200 resonates (S200) that the gyro sensor 200 does not resonate, in the applying of the signal to the gyro sensor 200 (S300), a start-up signal capable of generating resonance of the gyro sensor 200 may be applied to the gyro sensor 200.

A more specific example of the applying of the signal to the gyro sensor 200 (S300) of FIG. 7 will be described with reference to FIG. 8. Referring to FIG. 8, in the applying of the signal to the gyro sensor 200 (S1300), when it is determined that the gyro sensor 200 does not resonate as a result of determining whether or not the gyro sensor 200 resonates, a MOSFET switch 51 connected in parallel with an electrode of the gyro sensor 200 may be driven to apply instantaneous voltage having a potential difference from the electrode of the gyro sensor 200 to the electrode of the gyro sensor (S1330). In addition, in the applying of the signal to the gyro sensor 200 (S1300), when it is determined that the gyro sensor 200 resonates as a result of determining whether or not the gyro sensor 200 resonates, the MOSFET switch 51 connected in parallel with an electrode of the gyro sensor 200 is turned off to perform a control so that the drive signal is applied to the gyro sensor 200 (S1310).

Although not directly shown, describing another example with reference to FIG. 3, in the applying of the drive signal or the start-up signal to the gyro sensor 200 according to the result of determining whether or not the gyro sensor 200 resonates, the drive signal and a pulse signal having an adjacent frequency similar to a resonant frequency may be received and any one of them may be selected and applied to the gyro sensor 200 according to the determination of whether or not the gyro sensor 200 resonates. The pulse signal having the adjacent frequency similar to the resonant frequency may be a clock signal generated from an oscillator (not shown). Here, in the case in which the pulse signal having the adjacent frequency similar to the resonant frequency is selected, the pulse signal may be converted into a start-up signal through the drive signal generating unit 10 and be then applied to the gyro sensor 200. For example, in the applying of the drive signal or the start-up signal to the gyro sensor 200 according to the result of determining whether or not the gyro sensor 200 resonates, a digital multiplexer 53 receiving the drive signal as one input signal and receiving the pulse signal having the adjacent frequency similar to the resonant frequency of the gyro sensor 200 as another input signal is provided. Here, through the digital multiplexer 53, when it is determined that the gyro sensor 200 resonates, the drive signal may be output from the digital multiplexer 53 and be then applied to the gyro sensor 200, and when it is determined that the gyro sensor 200 does not resonate, the pulse signal may be output from the digital multiplexer 53 to thereby be applied as the start-up signal to the gyro sensor 200.

A more detailed description will be replaced by the description according to the first exemplary embodiment of the present invention described above.

Another example will be described with reference to FIG. 9.

Referring to FIG. 9, in the applying of the drive signal or the start-up signal to the gyro sensor 200 (S2300) according to the result of the determining of whether or not the gyro sensor 200 resonates (S200), the drive signal and the pulse signal having the adjacent frequency similar to the resonant frequency may be received, any one of them may be selected according to the determination of whether or not the gyro sensor 200 resonates, and the selected signal may be applied to the gyro sensor 200. The pulse signal having the adjacent frequency similar to the resonant frequency may be a clock signal generated from an oscillator (not shown). For example, a digital multiplexer receiving a signal converted from the output signal of the gyro sensor 200 as one input signal and receiving the pulse signal having the adjacent frequency similar to the resonant frequency of the gyro sensor 200 as another input signal is provided, such that when it is determined that the gyro sensor 200 resonates, the signal converted from the output signal of the gyro sensor 200 may be output from the digital multiplexer and the drive signal may be generated from the signal converted from the output signal of the gyro sensor 200 and output from the digital multiplexer to thereby be applied to the gyro sensor (S2310), and when it is determined that the gyro sensor 200 does not resonate, the pulse signal may be output from the digital multiplexer to thereby be applied as the start-up signal to the gyro sensor 200 (S2330).

As set forth above, according to the embodiment of the present invention, it is possible to drive the gyro sensor by determining whether or not the gyro sensor resonates and applying a self-start signal to the gyro sensor in the case in which the gyro sensor does not resonate due to several causes.

According to the embodiment of the present invention, the gyro sensor that does not resonate due to an offset resonates, thereby making it possible to reduce a defect rate of the gyro sensor.

In addition, according to the embodiment of the present invention, even in the case in which the gyro sensor stops due to external impact, the start-up signal applying circuit is automatically operated to allow the gyro sensor to resonate, thereby making it possible to perform continuous sensing.

It is obvious that various effects directly stated according to various exemplary embodiment of the present invention may be derived by those skilled in the art from various configurations according to the exemplary embodiments of the present invention.

The accompanying drawings and the above-mentioned exemplary embodiments have been illustratively provided in order to assist in understanding of those skilled in the art to which the present invention pertains rather than limiting a scope of the present invention. In addition, exemplary embodiments according to a combination of the above-mentioned configurations may be obviously implemented by those skilled in the art. Therefore, various exemplary embodiments of the present invention may be implemented in modified forms without departing from an essential feature of the present invention. In addition, a scope of the present invention should be interpreted according to claims and includes various modifications, alterations, and equivalences made by those skilled in the art.

What is claimed is:

1. A gyro sensor drive circuit comprising:
a drive signal generating unit receiving a signal converted from an output signal of a gyro sensor to generate a drive signal to be applied to the gyro sensor;
a resonance determining unit receiving the output signal of the gyro sensor, a demodulation signal for demodulating the output signal, or the drive signal to determine whether or not the gyro sensor resonates; and
a start signal applying unit allowing the drive signal to be applied to the gyro sensor when it is determined in the resonance determining unit that the gyro sensor resonates and allowing a start-up signal capable of generating resonance of the gyro sensor to be applied to the gyro sensor when it is determined in the resonance determining unit that the gyro sensor does not resonate.

2. The gyro sensor drive circuit according to claim 1, wherein the resonance determining unit receives the output signal of the gyro sensor and performs sampling using a sampling frequency larger than a resonant frequency of the gyro sensor during a sampling period to determine whether or not the gyro sensor resonates.

3. The gyro sensor drive circuit according to claim 1, wherein the resonance determining unit receives the demodulation signal output from the drive signal generating unit in order to demodulate the output signal of the gyro sensor or the drive signal generated in the drive signal generating unit and performs sampling using a sampling frequency larger than a resonant frequency of the gyro sensor during a sampling period to determine whether or not the gyro sensor resonates.

4. The gyro sensor drive circuit according to claim 1, wherein the start signal applying unit includes a metal oxide semiconductor field effect transistor (MOSFET) switch connected in parallel between the drive signal generating unit and an electrode of the gyro sensor, and
the MOSFET switch is driven according to a control signal applied when it is determined that the gyro sensor does not resonate, thereby allowing instantaneous voltage having a potential difference from the electrode of the gyro sensor to be applied to the electrode of the gyro sensor.

5. The gyro sensor drive circuit according to claim 1, wherein the start signal applying unit includes a digital multiplexer connected to a front end or a rear end of the drive signal generating unit, and
the digital multiplexer receives a signal converted from the output signal of the gyro sensor when being connected to the front end or the drive signal generated in the drive signal generating unit when being connected to the rear end as one input signal and receives a pulse signal having an adjacent frequency similar to a resonant frequency of the gyro sensor as another input signal, and outputs the pulse signal according to a control signal applied when it is determined that the gyro sensor does not resonate.

6. The gyro sensor drive circuit according to claim 1, further comprising a phase shifting unit receiving the output signal of the gyro sensor and generating a phase-shifted signal to provide the phase-shifted signal to the drive signal generating unit.

7. A gyro sensor system comprising:
a gyro sensor receiving a drive signal and outputs an output signal according to movement of an object;
a gyro sensor drive circuit according to claim 1 determining whether or not the gyro sensor resonates, generating the drive signal to apply the drive signal to the gyro sensor when it is determined that the gyro sensor resonates, and applying a start-up signal capable of generating resonance of the gyro sensor to the gyro sensor when it is determined that the gyro sensor does not resonate; and
a signal processing unit receiving the output signal of the gyro sensor and separating and outputting gyro component signals included in the output signal.

8. A gyro sensor system comprising:
a gyro sensor receiving a drive signal and outputs an output signal according to movement of an object;
a gyro sensor drive circuit according to claim 2 determining whether or not the gyro sensor resonates, generating the drive signal to apply the drive signal to the gyro sensor when it is determined that the gyro sensor resonates, and applying a start-up signal capable of generating resonance of the gyro sensor to the gyro sensor when it is determined that the gyro sensor does not resonate; and
a signal processing unit receiving the output signal of the gyro sensor and separating and outputting gyro component signals included in the output signal.

9. A gyro sensor system comprising:
a gyro sensor receiving a drive signal and outputs an output signal according to movement of an object;
a gyro sensor drive circuit according to claim 3 determining whether or not the gyro sensor resonates, generating the drive signal to apply the drive signal to the gyro sensor when it is determined that the gyro sensor resonates, and applying a start-up signal capable of generating resonance of the gyro sensor to the gyro sensor when it is determined that the gyro sensor does not resonate; and
a signal processing unit receiving the output signal of the gyro sensor and separating and outputting gyro component signals included in the output signal.

10. A gyro sensor system comprising:
a gyro sensor receiving a drive signal and outputs an output signal according to movement of an object;
a gyro sensor drive circuit according to claim 4 determining whether or not the gyro sensor resonates, generating the drive signal to apply the drive signal to the gyro sensor when it is determined that the gyro sensor resonates, and applying a start-up signal capable of generating resonance of the gyro sensor to the gyro sensor when it is determined that the gyro sensor does not resonate; and
a signal processing unit receiving the output signal of the gyro sensor and separating and outputting gyro component signals included in the output signal.

11. A gyro sensor system comprising:
a gyro sensor receiving a drive signal and outputs an output signal according to movement of an object;
a gyro sensor drive circuit according to claim 5 determining whether or not the gyro sensor resonates, generating the drive signal to apply the drive signal to the gyro sensor when it is determined that the gyro sensor resonates, and applying a start-up signal capable of generating resonance of the gyro sensor to the gyro sensor when it is determined that the gyro sensor does not resonate; and
a signal processing unit receiving the output signal of the gyro sensor and separating and outputting gyro component signals included in the output signal.

12. The gyro sensor system according to claim 7, wherein the signal processing unit includes:
an analog signal processing unit receiving the output signal of the gyro sensor and separate drive component signals and the gyro component signals included in the output signal from each other to remove the drive component signals and output the gyro component signals;
an analog-to-digital converting unit converting the signal processed in the analog signal processing unit into a digital signal; and
a digital signal processing unit digitally processing and outputting the converted digital signal.

13. The gyro sensor system according to claim 7, wherein the gyro sensor drive circuit applies the drive signal generated in the drive signal generating unit as a demodulation signal for separating the gyro component signals to the signal processing unit.

14. The gyro sensor system according to claim 7, wherein the gyro sensor is a piezoelectric vibration type gyro sensor or a capacitive vibration type gyro sensor.

15. A method for driving a gyro sensor, the method comprising:
receiving a signal converted from an output signal of a gyro sensor to generate a drive signal to be applied to the gyro sensor;
receiving the output signal of the gyro sensor, a demodulation signal for demodulating the output signal, or the drive signal to determine whether or not the gyro sensor resonates; and
applying the drive signal to the gyro sensor when it is determined that the gyro sensor resonates and applying a start-up signal capable of generating resonance of the gyro sensor to the gyro sensor when it is determined that the gyro sensor does not resonate, as a result of the determining of whether or not the gyro sensor resonates.

16. The method according to claim 15, wherein in the determining of whether or not the gyro sensor resonates, the output signal of the gyro sensor is received and sampling is performed using a sampling frequency larger than a resonant frequency of the gyro sensor during a sampling period to determine whether or not the gyro sensor resonates.

17. The method according to claim 15, wherein in the determining of whether or not the gyro sensor resonates, the demodulation signal output from the drive signal generating unit in order to demodulate the output signal of the gyro sensor or the drive signal generated in the drive signal generating unit is received and sampling is performed using a sampling frequency larger than a resonant frequency of the gyro sensor during a sampling period to determine whether or not the gyro sensor resonates.

18. The method according to claim 15, wherein in the applying of the drive signal or the start-up signal according to the result of the determining of whether or not the gyro sensor resonates, when it is determined that the gyro sensor does not resonate, a MOSFET switch connected in parallel with an electrode of the gyro sensor is driven to apply instantaneous voltage having a potential difference from the electrode of the gyro sensor to the electrode of the gyro sensor.

19. The method according to claim 15, wherein in the applying of the drive signal or the start-up signal according to the result of the determining of whether or not the gyro sensor resonates,
through a digital multiplexer receiving the drive signal as one input signal and receiving a pulse signal having an adjacent frequency similar to a resonant frequency of the gyro sensor as another input signal,
when it is determined that the gyro sensor resonates, the drive signal is output from the digital multiplexer to thereby be applied to the gyro sensor, and
when it is determined that the gyro sensor does not resonate, the pulse signal is output from the digital multiplexer to thereby be applied as the start-up signal to the gyro sensor.

20. The method according to claim 15, wherein in the applying of the drive signal or the start-up signal according to the result of the determining of whether or not the gyro sensor resonates,
through a digital multiplexer receiving a signal converted from the output signal of the gyro sensor as one input signal and receiving a pulse signal having an adjacent frequency similar to a resonant frequency of the gyro sensor as another input signal,
when it is determined that the gyro sensor resonates, the signal converted from the output signal of the gyro sensor is output from the digital multiplexer and the drive signal is generated from the signal converted from the output signal of the gyro sensor and output from the digital multiplexer to thereby be applied to the gyro sensor, and
when it is determined that the gyro sensor does not resonate, the pulse signal is output from the digital multiplexer to thereby be applied as the start-up signal to the gyro sensor.

21. The method according to claim 15, further comprising receiving the output signal of the gyro sensor and generating a phase-shifted signal to provide the phase-shifted signal as a signal for generating a drive signal.
